(19) United States
(12) Patent Application Publication
(10) Pub. No.: US 2008/0093029 A1
(43) Pub. Date: Apr. 24, 2008

(54) Apparatus for nondestructively removing layout pattern from wafer surface

(76) Inventor: Kuei-min Liao, Taichung (TW)

Correspondence Address: SAM CHEN, 7F-1, 293, ROOSEVELT ROAD, SEC 3, TAIPEI, omitted

(21) Appl. No.: 11/748,262

(22) Filed: May 14, 2007

(30) Foreign Application Priority Data
Oct. 24, 2006 (TW) 095139126

(51) Int. Cl. B29C 63/00

(52) U.S. Cl. 156/584

(57) ABSTRACT

An apparatus for removing layout pattern from a top metal layer of a defective wafer includes a removal device including horizontal sand spraying units and a blowing unit having a first sub-unit above the sand spraying units and a second sub-unit aligned with the first sub-unit and below the sand spraying units; and an endless, continuous conveyor for carrying the wafer from a wafer feed device and transferring the wafer to a wafer collecting device by passing a space between the sand spraying units and the second sub-unit. The sand spraying units are adapted to horizontally spray sand, and the first sub-unit is adapted to blow air toward the second sub-unit for sucking the sand onto a top of the passing wafer to smash the layout pattern in the metal layer to ashes with a remaining portion of the wafer being undamaged to be adapted to reuse or recycle.

### BACKGROUND OF THE INVENTION

1. Field of Invention

The invention relates to silicon wafer processing and more particularly to an apparatus for nondestructively removing layout pattern from the surface of a defective wafer so as to protect the remaining part of the wafer which is adapted to reuse or recycle in a cost effective manner.

2. Description of Related Art

Conventionally, silicon substrates are widely employed in semiconductor fabrication and solar based product manufacture. Further, solar product manufacturers typically buy defective wafers or wafer pieces from semiconductor fabrication companies as raw materials for manufacturing substrates of, for example, solar boards due to the consideration of cost reduction. Furthermore, metal layers on the surfaces of wafers are removed prior to the manufacturing.

Layout pattern (i.e., circuitry) is formed on the surface of a silicon wafer and it is know-how of a semiconductor fabrication company. Thus, it is typical for a semiconductor fabrication company to break defective wafers into pieces prior to selling to solar product manufacturers in order to prevent confidential technical information of the company from being disclosed. Wafer pieces are sold in a very cheap price by the semiconductor fabrication companies. Further, for solar product manufacturers, it is a time consuming process to extract useful silicon material from the pieces and thus cost increase is inevitable. This is not desired by both semiconductor fabrication companies and solar product manufacturers. Thus, it is desirable to provide a novel apparatus for nondestructively removing layout pattern from wafer surface so that the remaining intact part of the wafer can be cost effectively reused or recycled.

### SUMMARY OF THE INVENTION

It is therefore one object of the invention to provide an apparatus for nondestructively removing layout pattern from the surface of a defective wafer so as to protect the remaining part of the wafer. The obtained wafer having decreased thickness can be used as a test wafer or recycled as materials for manufacturing substrates of solar boards.

The above and other objects, features and advantages of the invention will become apparent from the following detailed description taken with the accompanying drawings.

### BRIEF DESCRIPTION OF THE DRAWINGS

FIG. 1 is a schematic side elevation of an apparatus according to the invention;

FIG. 2 is a schematic perspective view of the removal device;

FIG. 3 is a longitudinal sectional view of the wafer during the layout pattern removal process; and

FIG. 4 is a longitudinal sectional view of the wafer after the layout pattern removal process.

### DETAILED DESCRIPTION OF THE INVENTION

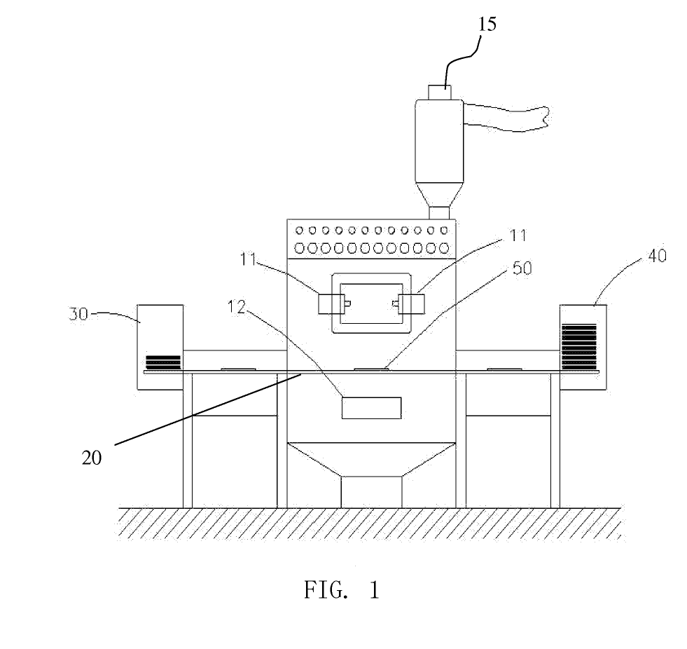

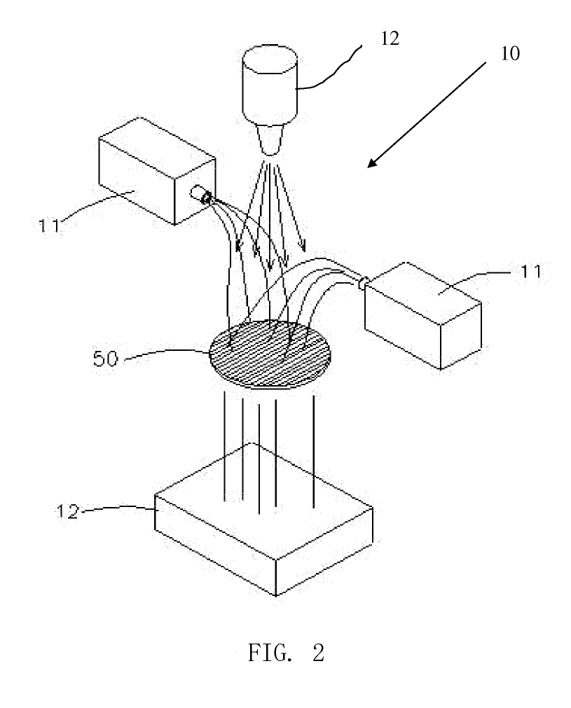

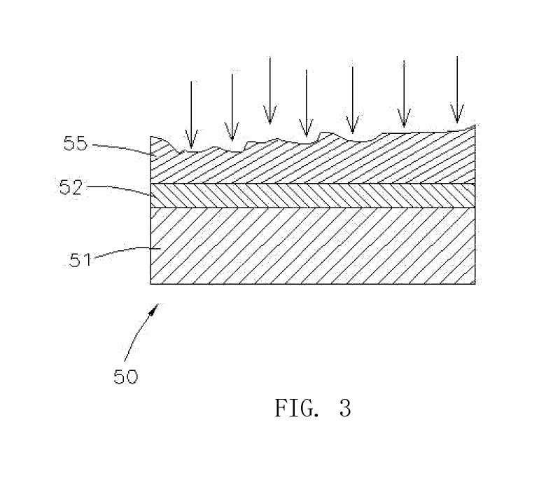

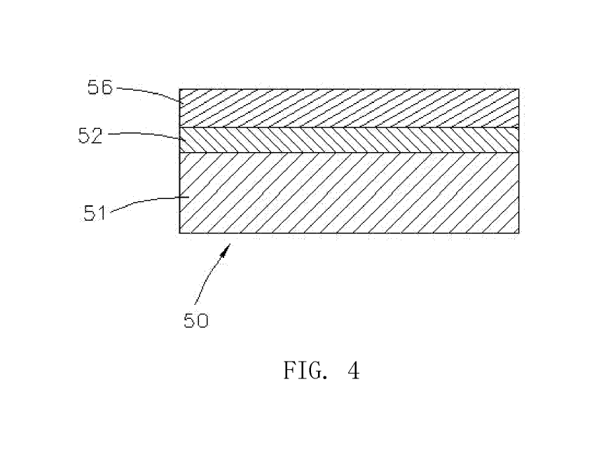

Referring to FIGS. 1 to 4, an apparatus in accordance with a preferred embodiment of the invention is shown. The apparatus is mounted on a vehicle (e.g., truck trailer) for collecting wafers from a semiconductor fabrication factory. The apparatus comprises a removal device 10, a conveyor 20, a wafer feed device 30, and a wafer collecting device 40. Each component is discussed in detail below.

The removal device 10 comprises a plurality of sand spraying units 11 provided horizontally and above the conveyor 20 by a predetermined distance, a blowing unit 12 having a first sub-unit right above the wafer 50 by a predetermined distance and a second sub-unit right below the wafer 50 by a predetermined distance, and a dust removing unit 15 above the sand spraying units 11.

The conveyor (e.g., a conveyor belt) 20 has one end passing the wafer feed device 30 for conveying defective wafers 50 to the wafer collecting device 40 at the other end by passing a space between the sand spraying units 11 and the second sub-unit of the blowing unit 12.

The multi-layer wafer 50 comprises a metal layer 55 on a top surface, a lower silicon substrate 51, and a film 52 between the metal layer 55 and the substrate 51.

In operation, the opposite sand spraying units 11 are adapted to horizontally spray sand toward each other. Further, the first sub-unit of the blowing unit 12 is adapted to blow air toward the second sub-unit thereof (i.e., toward the wafer 50). As a result, the sand is sucked and falls on a top surface of the wafer 50 like a trajectory. This arrangement aims to decrease the impinging force of sand exerted on the wafer 50. Otherwise, the film 52 and the substrate 51 thereunder may be damaged. Circuitry (i.e., layout pattern) on the top surface of the wafer 50 is destroyed and turns into dust and ashes. The dust removing unit 15 is adapted to draw the dust and ashes out of the removal device 10 so as to bring a minimum impact to the environment. A circuit-less layer 56 in the metal layer 55 is exposed at end of the layout pattern removal process. The wafers 50 collected at the wafer collecting device 40 are adapted to reuse or recycle as detailed later.

Thickness of the collected wafer is less than that of the defective wafer. In one application, the collected wafers are recycled as materials for fabricating test wafers when they have a thickness no less than 680 μm. In practice, a defective layout pattern can be used as a test wafer for three or four times by subjecting to the above layout pattern removal process. In another application, the collected wafers are recycled as materials for manufacturing substrates of solar boards when they have a thickness less than 680 μm.

While the invention herein disclosed has been described by means of specific embodiments, numerous modifications and variations could be made thereto by those skilled in the art without departing from the scope and spirit of the invention set forth in the claims.

What is claimed is:

1. An apparatus for removing layout pattern from a top metal layer of a defective wafer, comprising:
removal means comprising a plurality of horizontal sand spraying units and a blowing unit having a first sub-unit above the sand spraying units and a second sub-unit aligned with the first sub-unit and disposed below the sand spraying units;
wafer feed means;
wafer collecting means; and
endless, continuous conveying means for carrying the wafer from the wafer feed means and transferring the wafer to the wafer collecting means by passing a space between the sand spraying units and the second sub-unit of the blowing unit,
wherein the sand spraying units are adapted to horizontally spray sand, and the first sub-unit of the blowing unit is adapted to blow air toward the second sub-unit thereof for sucking the sand onto a top of the passing wafer to smash the layout pattern in the metal layer of the wafer to dust and ashes with a remaining portion of the wafer being undamaged.

2. The apparatus of claim 1, wherein the apparatus is mobile.

3. The apparatus of claim 1, wherein the removal means further comprises a dust removing unit above the sand spraying units.
